(19) United States
(12) Patent Application Publication
(10) Pub. No.: US 2009/0007743 A1
(43) Pub. Date: Jan. 8, 2009

(54) Table saw having changeable blades

(76) Inventor: Ben Yu, Taichung (TW)

Correspondence Address: CHARLES E. BAXLEY, ESQUIRE, 90 JOHN STREET, SUITE 309, NEW YORK, NY, 10038, US

(21) Appl. No.: 11/825,348

(22) Filed: Jul. 6, 2007

(51) Int. Cl. B27B 5/00; B23D 47/00; B27B 5/22

(52) U.S. Cl. 83/477

(57) ABSTRACT

A table saw includes a base having a spindle for changeably attaching two or more saw blades, a rail secured on the base, a carrier slidably engaged onto the rail for supporting a work piece, a table plate disposed on the base and having an opening facing toward the saw blades, and two or more inserts changeably engageable in the opening of the table plate and having a recess for fitting the saw blades of different width or thickness and for allowing the saw blades to be changed from each other and for conducting different sawing or working operations. The rail is preferably slidably and adjustably secured to the base for movably supporting the carrier.

### BACKGROUND OF THE INVENTION

1. Field of the Invention

The present invention relates to a table saw, and more particularly to a table saw including two or more saw blades that may be changed from each other for conducting different sawing or working operations.

2. Description of the Prior Art

Typical table saws comprise a work table including a table plate having a slot formed therein for receiving a rotating saw blade and for sawing or machining work pieces.

For example, U.S. Pat. No. 5,927,857 to Ceroll et al. discloses one of the typical machine tools including a fence movable relative to a cutting tool.

However, similarly, the work table includes an insert having an elongated slot formed therein through which a rotary cutting tool such as a circular saw blade protrudes. The elongated slot of the work table includes a predetermined size or width or length for fitting only the selected or predetermined rotary cutting tool, but may not be used for fitting the other rotary cutting tools.

U.S. Pat. No. 6,148,705 to Shieh and U.S. Pat. No. 6,189,429 to Liu disclose two further typical machine tools each also including an elongated slot formed in the work table for engaging with or for protruding a predetermined circular saw blade.

However, similarly, the elongated slots of the work tables also include a size or width or length that may be used for fitting only the selected or predetermined rotary cutting tool, but may not be used for fitting the other rotary cutting tools.

The present invention has arisen to mitigate and/or obviate the afore-described disadvantages of the conventional saw blades changing problems for table saws.

### SUMMARY OF THE INVENTION

The primary objective of the present invention is to provide a table saw including two or more saw blades that may be replaced or changed from each other for conducting different sawing or working operations.

In accordance with one aspect of the invention, there is provided a table saw comprising a base including a spindle, a first saw blade attachable to the spindle, at least one second saw blade changeably attachable to the spindle for allowing the first saw blade and the second saw blade to be changed from each other for conducting different sawing operations, a rail secured on the base, a carrier slidably engaged onto the rail for supporting a work piece, a table plate disposed on the base and located opposite to the carrier for allowing the first saw blade and the second saw blade to be disposed between the carrier and the table plate, the table plate including an opening formed therein and facing toward the first saw blade and the second saw blade, a first insert engageable in the opening of the table plate and having a recess formed therein for fitting the first saw blade, and at least one second insert engageable in the opening of the table plate and having a recess formed therein for fitting the second saw blade.

The table plate includes at least one protrusion extended into the opening thereof for selectively engaging with and supporting the first insert and the second insert. The base includes at least one stop attached thereto for contacting with the rail for limiting the rail to move relative to the base.

The table plate includes at least one depression formed therein, and the first insert and the second insert each include at least one projection extended outwardly therefrom for engaging with the depression of the table plate and for selectively anchoring the first insert and the second insert to the table plate.

The table plate includes at least one bar secured thereto. The bar includes at least one protrusion extended therefrom for engaging with and for selectively supporting the first insert and the second insert.

The base includes a flange having at least one groove formed therein for slidably receiving a fastener which slidably and adjustably secures the rail to the base. The rail includes at least one channel formed therein, an anchor slidably received in the channel of the rail and engaged with the fastener for adjustably securing the rail to the base.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view of a table saw in accordance with the present invention;

FIG. 2 is a partial perspective view of the table saw;

FIG. 3 is a partial perspective view similar to FIG. 2, illustrating the operation of the table saw;

FIG. 4 is a partial cross sectional view of the table saw taken along lines 4-4 of FIG. 2;

FIG. 5 is a partial cross sectional view similar to FIG. 4, illustrating the other arrangement of the table saw;

FIG. 6 is a partial exploded view similar to FIG. 1, illustrating the arrangement of the table saw as shown in FIG. 5;

FIG. 7 is a partial perspective view of the table saw as shown in FIGS. 5 and 6; and

FIG. 8 is a partial perspective view similar to FIG. 7, illustrating the operation of the table saw as shown in FIGS. 5-7.

### DETAILED DESCRIPTION OF THE PREFERRED EMBODIMENT

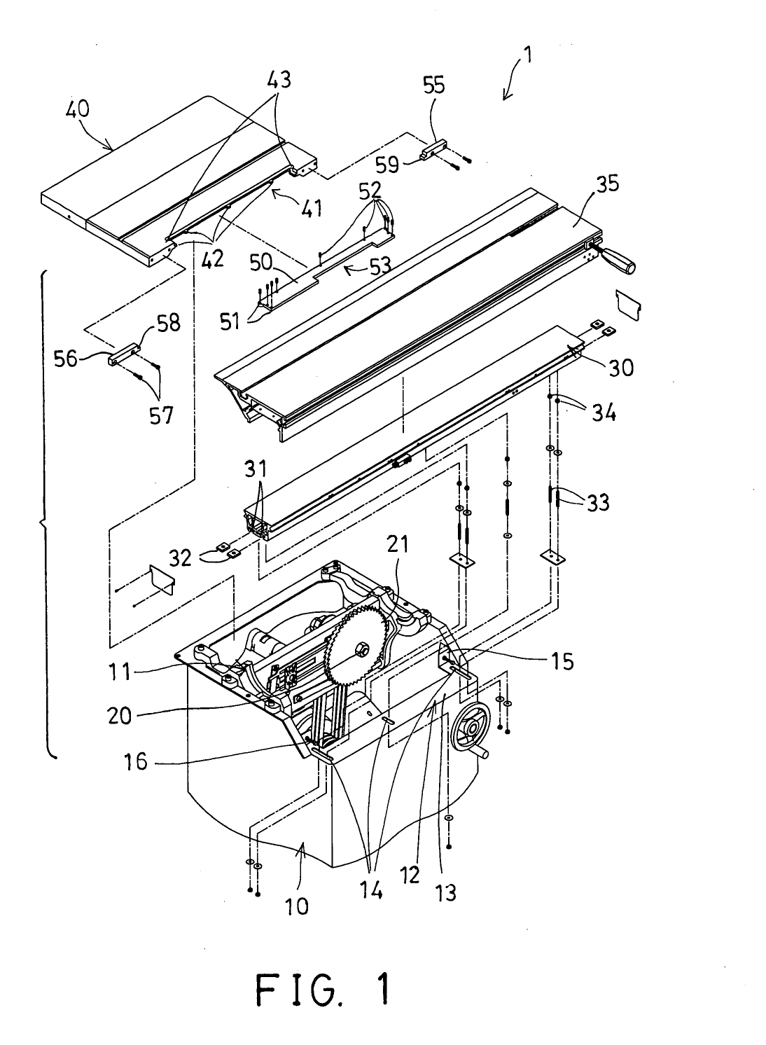

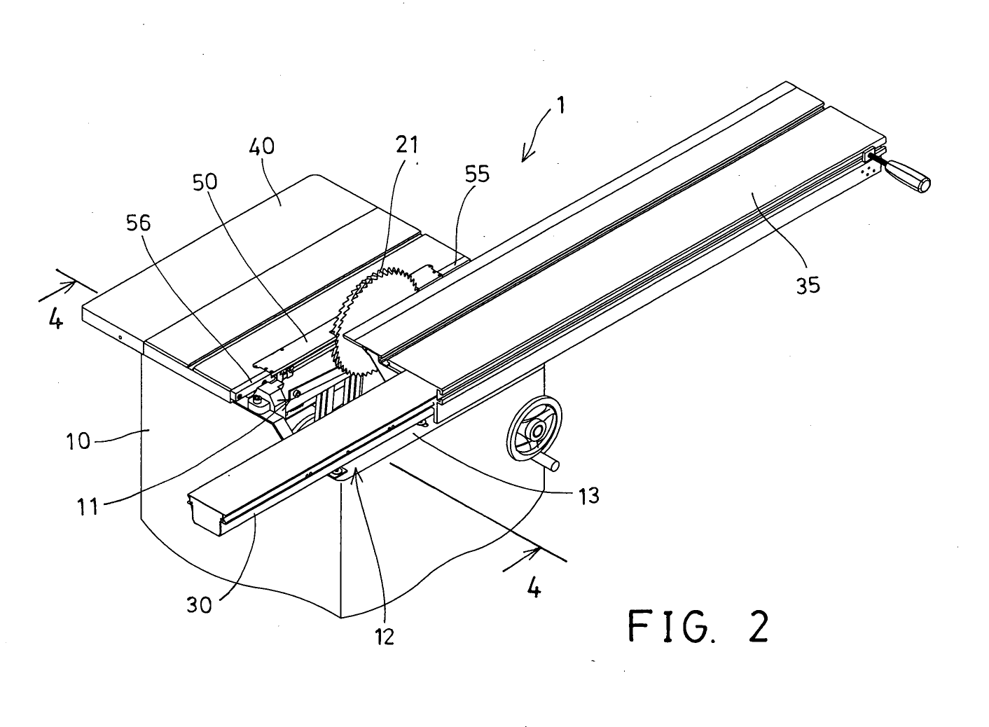

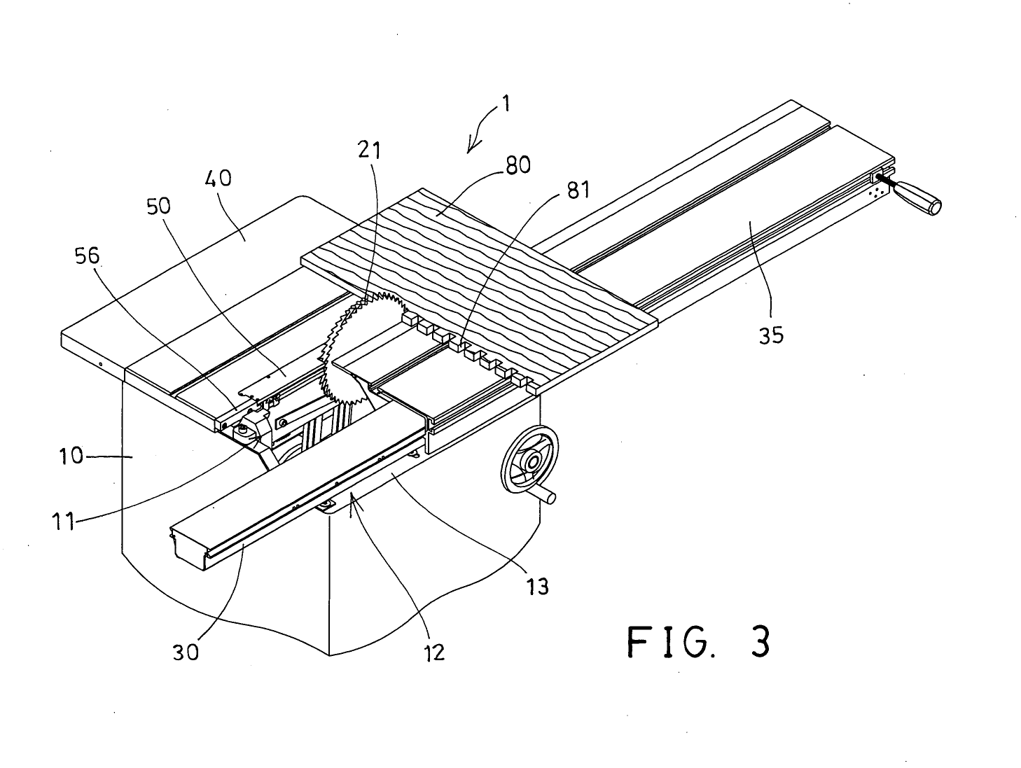

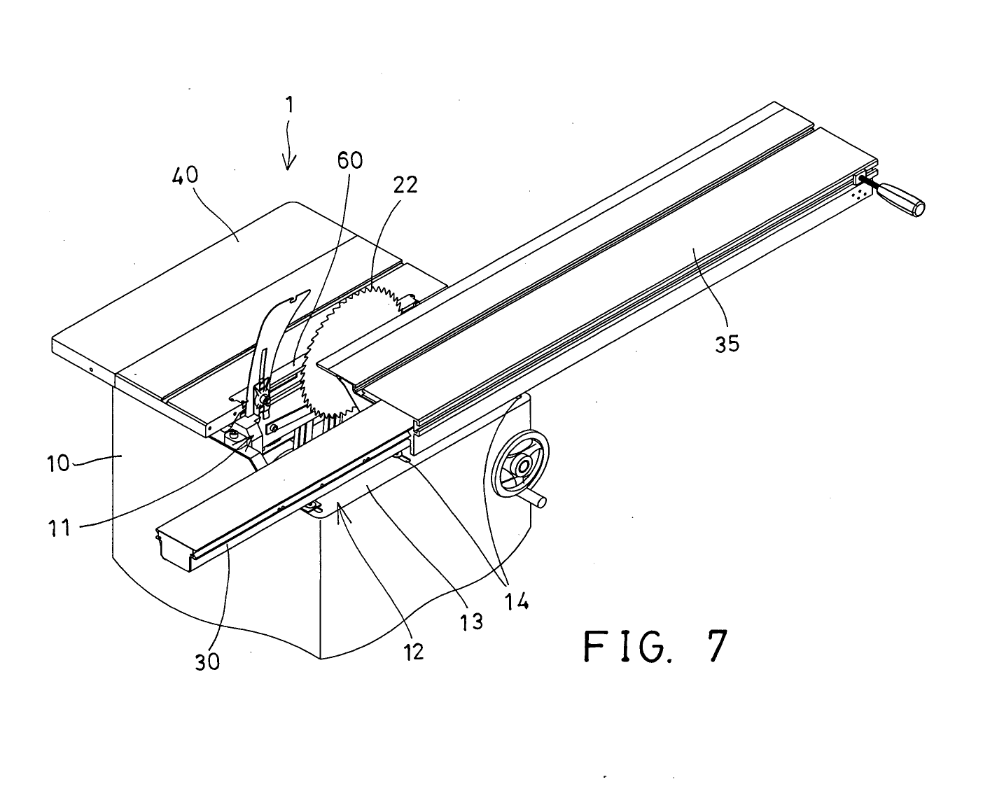

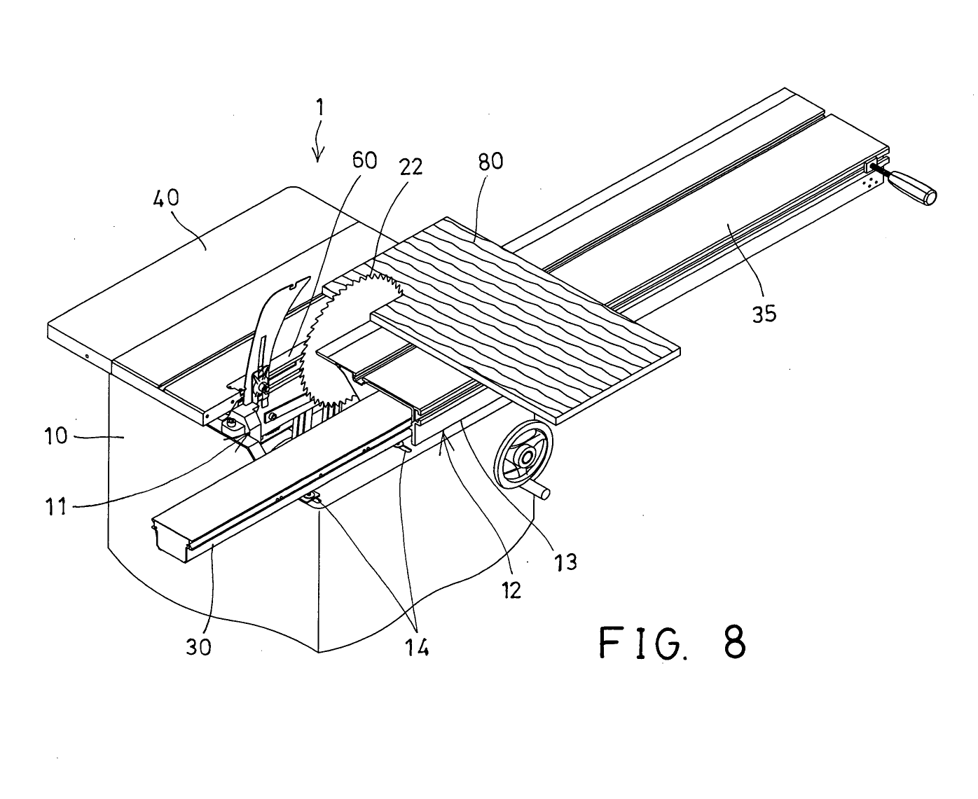

Referring to the drawings, and initially to FIGS. 1-4, a table saw 1 in accordance with the present invention comprises a table body or base 10 including a support device 11 having a spindle 20 for selectively or changeably or replaceably attaching two or more different saw blades 21 (FIGS. 1-4), 22 (FIGS.5-8) that may include different width or thickness or outer diameter, etc. For example, as shown in FIGS. 1-4, the saw blades 21 may be used for cutting troughs or notches 81 in a work piece 80 (FIG. 3), and the other saw blade 22 may be used for simply cutting the work piece 80 (FIG. 8), but may not be used for cutting troughs or notches in the work piece 80.

The base 10 includes a notch 12 formed in the front portion thereof and formed or defined by a flange 13 which includes one or more (such as three) grooves 14 formed therein and arranged parallel to the spindle 20 of the saw blades 21, 22 for adjustably supporting or attaching or securing a rail 30. The base 10 may further include one or more (such as two) ears 15 provided or extended therein and each having a stop 16 attached thereto. The rail 30 includes one or more (such as two) T-shaped channels 31 formed in the bottom portion thereof each for receiving one or more (such as three) anchors 32 therein, and a number of fasteners 33 are slidably engaged through the grooves 14 of the base 10 and engaged with the nuts 34 for adjustably or movably securing the rail 30 to the base 10.

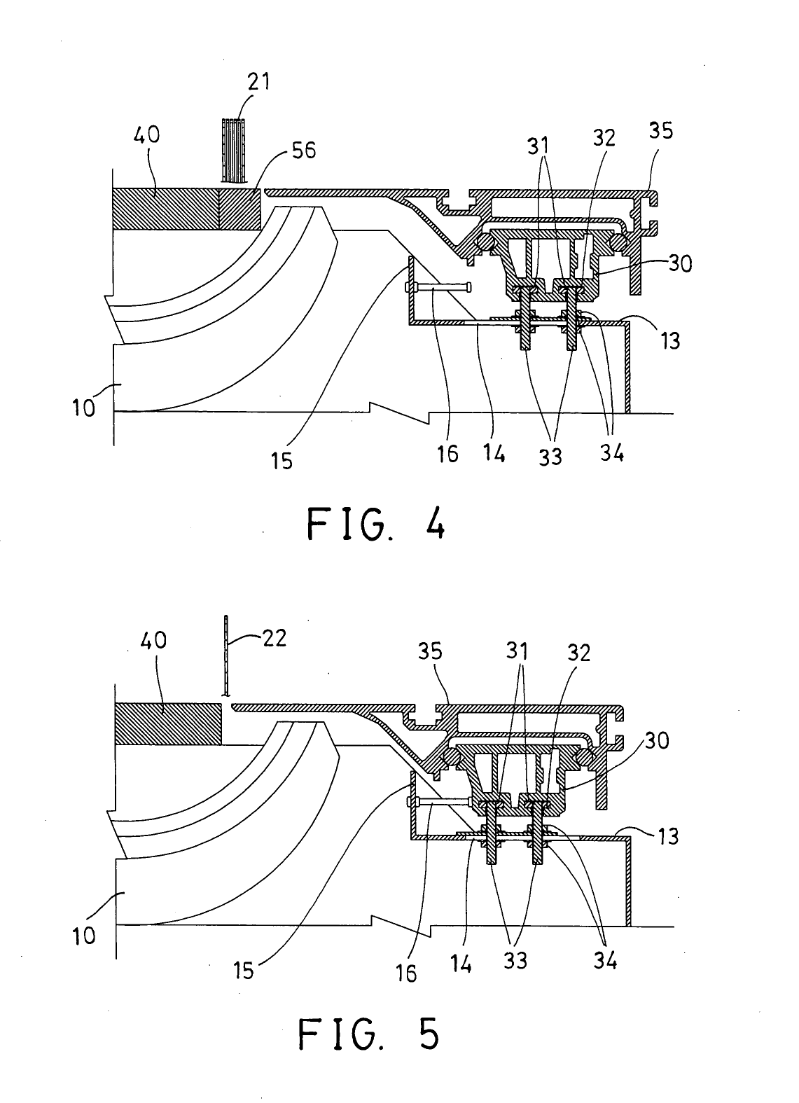

As shown in FIGS. 4 and 5, the fasteners 33 and thus the rail 30 may be moved or adjusted along the grooves 14 of the base 10 to any selected position before the nuts 34 secure the fasteners 33 and thus the rail 30 to the base 10. The stops 16 may be contacted or engaged with the rail 30 (FIG. 5) for guiding or limiting the rail 30 to move relative to the base 10. The grooves 14 of the base 10 may also be used to guide or limit the fasteners 33 and thus the rail 30 to move relative to the base 10 without the stops 16. A carrier 35 is slidably engaged onto the rail 30 for supporting the work piece 80 (FIGS. 3, 8), and the carrier 35 is moveable relative to the base 10 along the rail 30 for suitably moving the work piece 80 across the saw blades 21, 22.

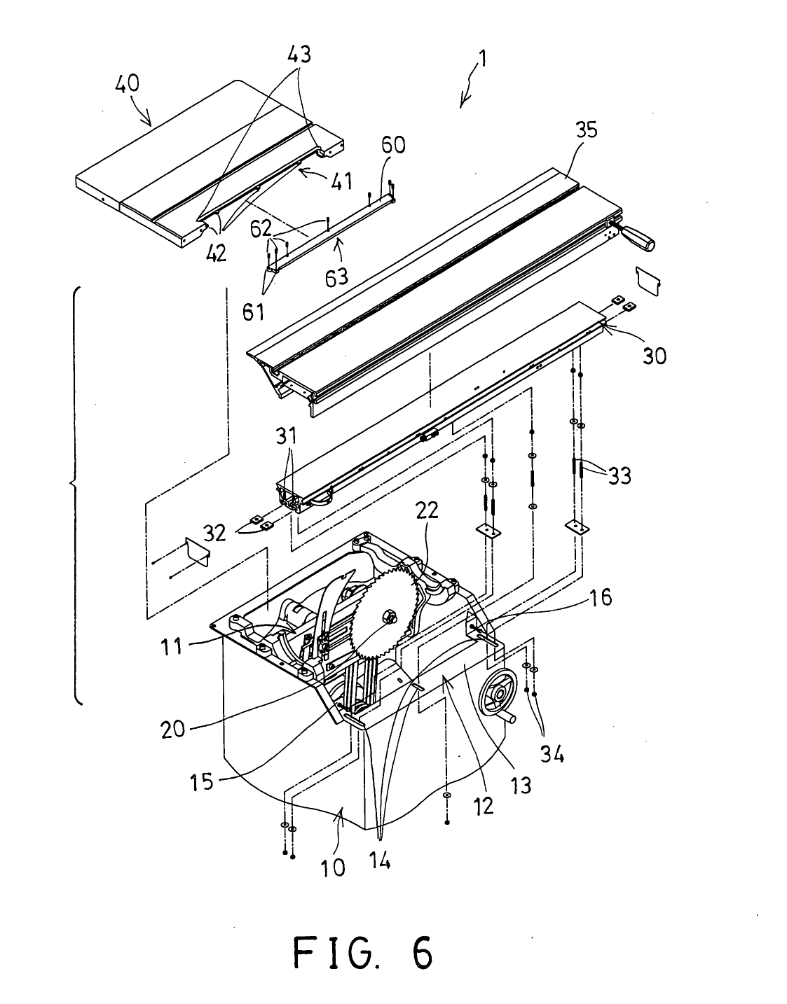

As also shown in FIGS. 4 and 5, the carrier 35 may also be moved or adjusted relative to the base 10 to any selected position according to the saw blades 21, 22 of different width or thickness, or for adjusting to the suitable distance between the saw blades 21, 22 and the carrier 35. The base 10 may further include a table plate 40 disposed thereon and located opposite to the carrier 35 for allowing the saw blades 21, 22 to be disposed or located between the carrier 35 and the table plate 40. As shown in FIGS. 1 and 6, the table plate 40 includes an opening 41 formed therein and facing toward the saw blades 21, 22 for attaching or receiving or supporting different panels or inserts 50, 60 that are provided for fitting or engaging with the saw blades 21, 22 of different width or thickness.

As also shown in FIGS. 1 and 6, the table plate 40 includes one or more protrusions 42 extended into the opening 41 thereof for engaging with and for supporting and for securing the inserts 50, 60, and includes one or more depressions 43 formed therein, and the inserts 50, 60, each may include one or more projections 51 extended outwardly therefrom for engaging with the depressions 43 of the table plate 40 and for anchoring the inserts 50, 60 to the table plate 40, and for preventing the inserts 50, 60 from being moved laterally or horizontally relative to the table plate 40, and the inserts 50, 60 may be solidly secured to the table plate 40 with such as fasteners 52, 62, and each may include a recess 53, 63 formed therein and for attaching or receiving or fitting the saw blades 21, 22 of different width or thickness.

For example, as shown in FIG. 1, the recess 53 of the insert 50 includes a shorter length and a greater width or depth than the recess 63 of the other insert 60 for allowing the saw blades 21, 22 of different width or thickness to be suitably received or fitted within the recesses 53, 63 of the inserts 50, 60 of different width or depth or length. The saw blades 21, 22 of different width or thickness may thus be replaced or changed from each other for conducting different sawing or working operations to the work pieces 80. As shown in FIGS. 1-4, due to the greater width of the insert 50 than the insert 60, one or more (such as two) bars 55, 56 may further be provided and attached or secured to the table plate 40 with fasteners 57. The bars 55, 56 each may include one or more protrusions 58, 59 extended therefrom for engaging with and for supporting and for securing the inserts 50, 60.

It is to be noted that the saw blades 21, 22 of different width or thickness may be easily replaced or changed from each other for conducting different sawing or working operations to the work pieces 80 such that the users are not required to purchase two bases 10 and carriers 35 and table plates 40. The inserts 50, 60 may include the recesses 53, 63 of different width or depth or length for attaching or receiving or fitting the saw blades 21, 22 of different width or thickness and for suitably shielding the saw blades 21, 22 and for preventing the cut chips or dirt from entering into the base 10.

Accordingly, the table saw in accordance with the present invention includes two or more saw blades that may be replaced or changed from each other for conducting different sawing or working operations.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A table saw comprising:
a base including a spindle,
a first saw blade attachable to said spindle,
at least one second saw blade changeably attachable to said spindle for allowing said first saw blade and said at least one second saw blade to be changed from each other for conducting different sawing operations,
a rail secured on said base,
a carrier slidably engaged onto said rail for supporting a work piece,
a table plate disposed on said base and located opposite to said carrier for allowing said first saw blade and said at least one second saw blade to be disposed between said carrier and said table plate, said table plate including an opening formed therein and facing toward said first saw blade and said at least one second saw blade,
a first insert engageable in said opening of said table plate and having a recess formed therein for fitting said first saw blade, and
at least one second insert engageable in said opening of said table plate and having a recess formed therein for fitting said at least one second saw blade.

2. The table saw as claimed in claim 1, wherein said table plate includes at least one protrusion extended into said opening thereof for selectively engaging with and supporting said first insert and said at least one second insert.

3. The table saw as claimed in claim 1, wherein said table plate includes at least one depression formed therein, and said first insert and said at least one second insert each include at least one projection extended outwardly therefrom for engaging with said at least one depression of said table plate and for selectively anchoring said first insert and said at least one second insert to said table plate.

4. The table saw as claimed in claim 1, wherein said table plate includes at least one bar secured thereto.

5. The table saw as claimed in claim 4, wherein said at least one bar includes at least one protrusion extended therefrom for engaging with and for selectively supporting said first insert and said at least one second insert.

6. The table saw as claimed in claim 1, wherein said base includes a flange having at least one groove formed therein for slidably receiving a fastener which slidably and adjustably secures said rail to said base.

7. The table saw as claimed in claim 6, wherein said rail includes at least one channel formed therein, an anchor slidably received in said at least one channel of said rail and engaged with said fastener for adjustably securing said rail to said base.

8. The table saw as claimed in claim 1, wherein said base includes at least one stop attached thereto for contacting with said rail for limiting said rail to move relative to said base.
